(19) United States
(12) Patent Application Publication
(10) Pub. No.: US 2015/0248417 A1
(43) Pub. Date: Sep. 3, 2015

(54) METHOD FOR SYNCHRONIZING DYNAMIC ATTRIBUTES OF OBJECTS IN A DATABASE SYSTEM HAVING AN ARCHIVE

(71) Applicant: ARTEC COMPUTER GMBH, Karben (DE)

(72) Inventors: Jerry John Artishdad, Karben (DE); Christian Hett, Niddatal (DE); Nils Artishdad, Karben (DE)

(21) Appl. No.: 14/417,206

(22) PCT Filed: Jul. 30, 2013
(86) PCT No.: PCT/EP2013/066027

§ 371 Date: Jan. 26, 2015

(30) Foreign Application Priority Data
Aug. 1, 2012 (DE) 10 2012 107 031.8

(51) Int. Cl. G06F 17/30

(52) U.S. Cl. CPC G06F 17/30073; G06F 17/30581; G06F 17/30864; G06F 17/30949

(57) ABSTRACT

The invention relates to a method that is used to synchronize dynamic attributes of objects in a database system having an archive system. The possibility is created to also synchronize databases for which synchronization is not provided, in accordance with this method. For this purpose, an additional dynamic attribute or one additional dynamic attribute per attribute to be synchronized is introduced. By means of said attributes, it can be detected whether the particular object in the database system has been changed and synchronization between the database system and an archive system must be performed as a result thereof in order to have the object attributes archived in the current form thereof in the archive system.

The present invention relates to a method used to synchronize dynamic attributes of objects in a database system with an archive system. In particular, the possibility is also to be created here to accordingly synchronize database systems for which synchronization is not provided using this method.

As a basic principle, one should protect a database system for backup purposes or archive purposes for example in an archive system. Particularly for archive purposes, there is also the requirement that the database objects be protected against change, which is usually achieved by a signature. This results in particular difficulties for synchronization when the dynamic object attributes that can be changed by the user of the database are to be synchronized with the archive system. A particularly pronounced example of this kind is database systems for managing emails.

In general, database systems that are designed in such a way that they can be synchronized with an archive system that has been developed accordingly for this purpose are already known. However, these database systems and the associated archive system are extensively limited to their particular function and structure. As a rule, one creates a simple copy of the database files (or parts thereof) that is not protected against change. Also, for example, it can occur that the database system offers no suitable interfaces whatsoever or the user of these interfaces does not want to or is unable to use these interfaces for one reason or another.

The object of the present invention is therefore to establish a method of synchronizing dynamic object attributes that enables a database system to be synchronized with an archive system such that the synchronization can also be carried out without interfaces being provided or as an alternative thereto.

This object is achieved with the help of a method of synchronizing dynamic attributes of objects in a database system with an archive system with the help of an additional dynamic attribute or one additional dynamic attribute per attribute to be synchronized including at least the following steps:
When used for the first time, define one or more additional dynamic object attributes in the database system by means of the archive system if the database system does not automatically create them when the value is first assigned,
Query all the objects in the database system for which the value/values of the one or more additional dynamic object attributes is/are empty or does not correspond to the value or a value derived therefrom of the corresponding object attribute in the database system,
Search and find the queried objects in the archive system,
Copy the object attributes from the database system to the archive system,
Mark the processed query result in the database system by writing the value of the object attributes in the form in which it was returned by the query or a value derived therefrom to the respectively corresponding additional dynamic object attribute of the database system.

Herein, for synchronization, an archive system is not only understood to mean a pure archive system in the narrower sense, but also, for example, mobile clients or physically separated backup systems. Consequently, synchronization should also be designed to make the best possible use of bandwidth.

Many database systems provide the option of extending the database objects with additional dynamic attributes and all normally have a query facility. The present invention makes use of these two features.

When the method of synchronizing dynamic attributes in a database system with an archive system is used for the first time, the additional dynamic object attributes according to the invention must first be defined in the database system. When using classic databases, one must explicitly define in advance which attributes are even to be considered or even exist for a value assignment. On the other hand, this problem does not occur with “modern NoSQL” databases, as these databases allow every object to be assigned any attribute without defining it in advance. When assigned for the first time, the new attribute is automatically created by the database and defined for the whole database. With this type of database, the initializing first step of the method according to the invention can therefore be omitted.

With these additional dynamic object attributes, the archive system is able to detect and subsequently synchronize with respect to the monitored object attributes changes that do not necessarily have to include all the attributes assigned to the objects. There are two possibilities for the case where a plurality of object attributes is to be synchronized.

On the one hand, one can define a single additional dynamic object attribute to which a value derived from the object attributes to be synchronized is assigned as a value. Depending on the type of attribute, in the simplest case, the derivation can be a linking of the attributes. In a preferred embodiment, the derivation is a hash function that enables a particularly effective query. If at least one of the object attributes to be synchronized changes, the comparison of the object attribute values, which are derived in the same way, with the additional dynamic object attribute will indicate this. Although it is then impossible to say which object attribute or attributes have changed, the values for all object attributes to be synchronized can then simply be copied to the archive system. As the attributes are very small in comparison with the objects, this only requires a small amount of bandwidth with reduced complexity for the calculation of the derivations of the values and the smaller number of database queries compared with individual monitoring. In this respect, this method is particularly suitable for database objects with which a plurality of attributes frequently have to be changed simultaneously in the synchronization interval.

The second possibility lies in the use of an additional dynamic object attribute per object attribute to be synchronized. Here, specifically, only the changed object attributes need to be synchronized in each case, which is advantageous in the case of database objects with which, as a rule, only one attribute or at least a small proportion of the attributes compared with the total number of monitored attributes is changed in the synchronization interval. In the simplest case, a copy of the value of the corresponding attribute to be synchronized is created in the additional dynamic object attribute each time. Also advantageous here is a variant in which the value is not created directly at this point but the result of a hash function relating thereto. The query is then again carried out in a similar way using the hash value of the attribute to be synchronized compared with the additional dynamic object attribute.

As the first actual method step for synchronization, this possibly necessary preparatory step is followed by a query of all those objects located in the database system and the values of the additional dynamic object attributes that are empty or are not the same as the values of the corresponding object attributes to be synchronized in the database system. Here, it is advantageous when this query is divided by the archive system into data blocks with variable size. In this way, the archive system can initially process the response to for example 1000 hits before a new block is requested. In addition, in this way, any throttling mechanisms or blocks against queries that are too large or that take too long are not triggered.

The object attributes detected by the query as having changed are then copied to the archive system by first searching for the affected objects in the archive system. Here, it is particularly advantageous when, while doing this, the archive system can have recourse to unique identifiers.

If the objects are not already contained in the archive system, which can be seen from the fact that their additional dynamic object attributes in the database system are still empty or can be seen from the fact that the objects in the archive system have not been found based on a unique identifier, the synchronization method according to the invention can advantageously be extended in that the objects found during the query, including their attributes, are written by the database system to the archive system. In this way, the archiving operation can be linked to the synchronizing operation of the object attributes and processed in one pass. If necessary, in this way, objects that may have evaded a normal archiving operation can also be retrospectively detected and copied to the archive system.

In order not to find query results again that have already been processed during the search, these are finally marked in the database system. This takes place such that—depending on the variant of the method used—the value of the object attribute or the value derived therefrom or the value derived from a plurality of object attributes returned by the query is written to the appropriate additional dynamic object attribute of the database system. A renewed query of the database system with the same criteria therefore only returns a hit when at least one object attribute has been changed. If the query has been restricted to for example 1000 elements, the query returns further objects to be synchronized but not those just marked as processed.

It is important when marking that the archive system uses the values from the query response for assigning values to the additional dynamic object attributes and does not use a copy of the corresponding object attribute value in the database system. This enables the elimination of so-called “race conditions” that occur when the object attribute in question is changed immediately after the query and before the additional object attribute value is set. If, in this case, the (now already new) value is simply copied within the database system, only the interim value would appear in the archive system. However, a new query would not detect that the object attribute had changed, as the comparison would take place with the copied new value. On the other hand, by using the value from the query, the change is detected and the archive system aligned accordingly in the event of a new query.

An important aspect for the method according to the invention is the fact that, here, the main computational work is carried out by the database system. The archive system sends and receives only small data packets with queries to and responses from the database system, which makes the method particularly suitable for use between geographically separate systems. In addition, database systems are usually equipped with efficient query functions and often have advanced caching and index techniques so that they are able to carry out such tasks considerably better than an external archive system that, in return, can be structured and equipped more simply and also does not have to burden the database system with the inefficient repeated listing of all objects.

In a further embodiment of the method according to the invention, the object attributes to be synchronized are folder names or complete folder paths. In this case, a modified form of the method according to the invention is used, provided that the database system offers the possibility of querying the folders present in the system. Here, the objects are processed folder-by-folder in that the archive system first requests a list of the folders from the database system and calculates the respective hash value from the complete folder path. For synchronization, it then queries all objects of the folders of the database system for which the additional dynamic object attribute is empty or does not correspond to the hash value calculated for this folder. After the object attribute has been synchronized, it marks the processed query results by writing the calculated hash value to the additional dynamic object attribute.

This procedure offers a considerable advantage, since the hash value of the attribute to be checked is constant within a folder and must therefore only be calculated once by the archive system and is constant within the query sent to the database system. In certain cases, the query language of the database system does not allow queries with conditions that contain complex calculations, such as the formation of a hash value of an object attribute, but only simple comparisons with constant values. As a result of this procedure, even in this special case, synchronization can take place using the method according to the invention, or a particularly efficient index or cache of the database system can be used.

Furthermore, the hash function used for processing the object attributes can advantageously contain additional information such as serial numbers, tokens, secret keys etc, where the secret key can be any value contained in the program code of the archive system. The linking of the object attribute to one or more of these items of information before calculating the hash value forms a safety feature for the archive system function.

As a result of the linking, it is no longer possible for a user of the database system to draw a conclusion with relatively simple means from the value of the object attribute known to him regarding the content of the additional dynamic object attribute used for marking that may also have become known to him. He therefore cannot extract his data records from the synchronization or from the retrospective detection of the object by specific manipulation of the additional dynamic object attribute.

Further, the hash function can be extended by any chosen character sequences. This so-called salt can, for example, be the date on the day on which the system was installed. This extension of the value to be hashed provides the option of initiating a complete new synchronization of the database system by changing only one value. If this function is provided in the archive system, the user only needs to change the value that forms the salt so that the hash value differs from the one used before—even when the object attribute values to be synchronized are unchanged. The query therefore recognizes all monitored object attributes as being changed and the archive system accordingly resynchronizes them. This highly efficient technique requires no changes of any kind to the values in the database system and certainly not to a plurality or even all object attributes, but only a single change to one value in the archive system.

In order to protect the objects transmitted from the database system to the archive system against change, on entering the archive system, the received objects are provided by this system with a signature or are signed by a time stamp service. However, the attributes of the received objects are exempted from signing. As a result, database objects whose integrity is important, can be protected against changes and yet, at the same time, the dynamic object attributes are maintained at the current state of the database system.

If exactly two or more archive systems have access to the database system, the additional dynamic object attributes are preferably provided with a respective identifier that contains identification characteristics of its archive system. These can be, for example, the serial numbers, MAC addresses, unique device designations and the like. As a result, each archive system has its own synchronization indicator, which so that the systems do not mutually overwrite this and can work independently of one another. In particular, for the case where an identification characteristic of the archive system is included in the additional dynamic object attribute, this prevents two systems from mutually overwriting a dynamic attribute on each pass and therefore objects being resynchronized on each pass. In the case where an identification characteristic of the archive system is not included in the additional dynamic object attribute or in its identifier, as a rule, a change would only be noticed and synchronized by an archive system.

Preferably, each database system has a respective access-protected user account for each user that can be accessed separately. The synchronization can therefore be carried out separately for each of the individual users. Further preferably, the archive system itself has an access-protected administration account or a special trust setting that enables it to access all user accounts of the database system. This avoids having to exchange access data with the database system or having to store access data in the archive system for all user accounts.

In order to be able to limit access to certain accounts or to be able to determine query parameters, it is expedient when the archive system uses a directory service such as LDAP to request a list of user accounts whose objects are to be synchronized.

A further option of the method according to the invention is that the archive system carries out further actions on the archive system and/or the database system based on a defined set of rules depending on the value of the synchronized object attributes. This enables functions to be initiated that are otherwise not provided or possible, and with which the user of the database system can set a desired minimum retention time of the object in the archive system, for example by setting a certain value of one of the monitored dynamic object attributes defined in the set of rules stored on the archive system, or effect an immediate deletion. Also, for example, this enables particular storage locations or types to be defined or various report functions to be implemented.

A particularly preferred embodiment of the method according to the invention is its use for synchronizing an email archive, where the objects, the dynamic attributes of which are synchronized, are emails. In this case, preferably, the globally uniquely assigned message ID is used as the unique identifier for finding the objects in the archive system. This offers the advantage that the objects can always be unambiguously assigned to the query result regardless of the way in which they are accepted into the archive system (for example journaling function, direct mail server access, recording of network traffic, import of old data or old archives or similar).

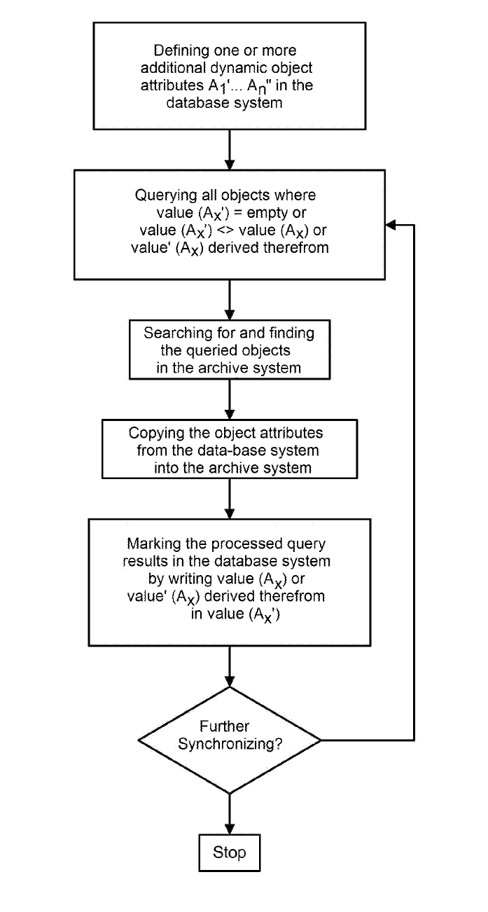

FIG. 1 shows the functional principle of the claimed method that, at the beginning of the method, defines one or more additional dynamic object attributes A₁′ . . . Aₙ′ in a database system if this is explicitly necessary for the database system in advance. In the next step of FIG. 1, all objects for which the value of Aₓ′ is either empty or different from the value of Aₓ or a value′ of Ax derived therefrom are queried. When the queried objects have been sought and found in the archive system, the object attributes are copied from the database to the archive system. In the next step, the processed query results are marked in the database system by writing the value of Aₓ or the value′ Aₓ derived therefrom to the value Aₓ′. The synchronization operation is thereby complete and can be repeated if necessary.

In the following embodiment, the database system is a mail system, such as Microsoft® Exchange for example, and the archive system is an email archiving solution. A possible simplified communication between the archive system and the database system using the SOAP network protocol is shown. This exemplary embodiment is intended to explain how, in the event of a query, the folders are listed and how the relevant objects are sought in the respective folder. In addition, this embodiment shows how the marking of the individual objects takes place so that they are not found again in a further query.

To list the folders, the archive system sends the following query to the database system:

<?xml version=”1.0” encoding=”utf-8”?>
<soap:Envelope>

<soap:Body>

<FindFolder Traversal=”Deep”>

<FolderShape>

<t:BaseShape>IdOnly</t:BaseShape>
<t:AdditionalProperties>

<t:FieldURI FieldURI=”folder:DisplayName” />
<t:FieldURI FieldURI=”folder:ParentFolderId” />

</t:AdditionalProperties>

</FolderShape>
<IndexedPageFolderView MaxEntriesReturned=”1000”

Offset=”0” BasePoint=”Beginning” />

<ParentFolderIds>

<t:DistinguishedFolderId Id=”msgfolderroot” />

</ParentFolderIds>

</FindFolder>

</soap:Body>

</soap:Envelope>

The possible response to the example list query appears as follows:

<?xml version=”1.0” encoding=”utf-8”?>
<s:Envelope>

<s:Body>

<m:FindFolderResponse>

<m:ResponseMessages>

<m:FindFolderResponseMessage ResponseClass=”Success”>

<m:ResponseCode>NoError</m:ResponseCode>
<m:RootFolder IndexedPagingOffset=”19” TotalItemsInView=”19”

IncludesLastItemInRange=”true”>

<t:Folders>

<t:Folder>

<t:FolderId

Id=”AAMkcmub9yM990hQbRGdoWQ1zw0AAAZufe0AAA=”/>

<t:ParentFolderId

Id=”AAMkADRmOhQbRGdoWQ1zw0AAAZufeoAAA=” ChangeKey=”AQAAAA==”/>

<t:DisplayName>Quartal 4</t:DisplayName>

</t:Folder>
<t:Folder>

<t:FolderId Id=”AAMkADRmfe2AAA=”/>
<t:ParentFolderId

Id=”AAMkcmub9yM990hQbRGdoWQ1zw0AAAZufe0AAA =”/>

<t:DisplayName>FirmaXYZ</t:DisplayName>

</t:Folder>

</t:Folders>

</m:RootFolder>

</m:FindFolderResponseMessage>

</m:ResponseMessages>

</m:FindFolderResponse>

</s:Body>

</s:Envelope>

Next follows the listing of a maximum of 500 objects to be synchronized in the folder “Company XYZ” with the folder ID “AAMkADRmfe2AAA=”. For listing, the relevant objects are sought, here the message ID is queried, as this is globally unique and can be archived and retrieved by an archive system by journaling. In this example, the attribute identifier in the form of a GUID is made up of the constant part “B29C11BF-46C7-4AB6-BDF6-2545016” and the serial number of the archive system “54183”. The query determines whether this exists or has the correct value. The value sought “1242656501” is calculated from a hash value from a linking of the folder with the serial number and a secret value shortened to the size of a long type variable.

<?xml version=”1.0” encoding=”utf-8”?>
<soap:Envelope>

<soap:Body>

<FindItem Traversal=”Shallow”>

<ItemShape>

<t:BaseShape>IdOnly</t:BaseShape>
<t:AdditionalProperties>

<t:FieldURI FieldURI=”message:InternetMessageId” />

</t:AdditionalProperties>

</ItemShape>
<IndexedPageItemView MaxEntriesReturned=”500” Offset=”0”

BasePoint=”Beginning” />

<Restriction>

<t:And>

<t:Exists>

<t:FieldURI FieldURI=”message:InternetMessageId” />

</t:Exists>
<t:Or>

<t:Not>

<t:Exists>

<t:ExtendedFieldURI PropertySetId=”B29C11BF-46C7-4AB6-BDF6-

254501654183” PropertyName=”EWS Folder Sync Mark 54183” PropertyType=”Long”
/>

</t:Exists>

</t:Not>
<t:IsNotEqualTo>

<t:ExtendedFieldURI PropertySetId=”B29C11BF-46C7-4AB6-BDF6-

254501654183” PropertyName=”EWS Folder Sync Mark 54183” PropertyType=”Long”
/>

<t:FieldURIOrConstant>

<t:Constant Value=”1242656501” />

</t:FieldURIOrConstant>

</t:IsNotEqualTo>

</t:Or>

</t:And>

</Restriction>
<ParentFolderIds>

<t:FolderId Id=”AAMkADRmfe2AAA=” />

</ParentFolderIds>

</FindItem>

</soap:Body>

</soap:Envelope>

A successful search is output in the following example response. An object to be synchronized has been found and the search does not have to be repeated immediately, i.e. there were less than 500 results. The message ID “44306E02B9BA297B@example.de” of the object to be synchronized, which was assigned when sending the email and with the help of which the email can be found in the archive system, is also returned:

<?xml version=”1.0” encoding=”utf-8”?>
<s:Envelope>

<s:Body>

<m:FindItemResponse>

<m:ResponseMessages>

<m:FindItemResponseMessage ResponseClass=”Success”>

<m:ResponseCode>NoError</m:ResponseCode>
<m:RootFolder IndexedPagingOffset=”1” TotalItemsInView=”1”

IncludesLastItemInRange=”true”>

<t:Items>

<t:Message>

<t:ItemId Id=”AAMkADRmYAAAZuffhAAA=” ChangeKey=” CQAAAufnh”/>
<t:ExtendedProperty>

<t:ExtendedFieldURI PropertyTag=”0x75”

PropertyType=”String”/>

<t:Value>EX</t:Value>

</t:ExtendedProperty>

<t:InternetMessageId>&lt;44306E02B9BA297B@example.de&gt;</t:InternetMessageId>

</t:Message>

</t:Items>

</m:RootFolder>

</m:FindItemResponseMessage>

</m:ResponseMessages>

</m:FindItemResponse>

</s:Body>

</s:Envelope>

To mark the found object as complete so that it can no longer be found in a further search query, the archive system sends the following query to the database system:

<?xml version=”1.0” encoding=”utf-8”?>
<soap:Envelope>

<soap:Body>

<UpdateItem ConflictResolution=”AlwaysOverwrite”

MessageDisposition=”SaveOnly”>

<ItemChanges>

<t:ItemChange>

<t:ItemId Id=”AAMkADRmYAAAZuffhAAA=” ChangeKey=”CQAAAufnh” />
<t:Updates>

<t:SetItemField>

<t:ExtendedFieldURI PropertySetId=”B29C11BF-46C7-4AB6-BDF6-

254501654183” PropertyName=”EWS Folder Sync Mark 54183”
PropertyType=”Long” />

<t:Value>1242656501</t:Value>

</t:SetItemField>

</t:Updates>

</t:ItemChange>

</ItemChanges>

</UpdateItem>

</soap:Body>

</soap:Envelope>

Success is confirmed by the database system with the following response:

<?xml version=”1.0” encoding=”utf-8”?>
<s:Envelope>

<s:Body>

<m:UpdateItemResponse>

<m:ResponseMessages>

<m:UpdateItemResponseMessage ResponseClass=”Success”>

<m:ResponseCode>NoError</m:ResponseCode>
<m:Items>

<t:Message>

<t:ItemId Id=”AAMkADRmYAAAZuffhAAA=” ChangeKey=”CQAAAufnr”/>

</t:Message>

</m:Items>

</m:UpdateItemResponseMessage>

</m:ResponseMessages>

</m:UpdateItemResponse>

</s:Body>

</s:Envelope>

1. A method of synchronizing dynamic attributes of objects in a database system with an archive system with the help of an additional dynamic attribute or one additional dynamic attribute per attribute to be synchronized, the method comprising the steps of:
when used for the first time, defining one or more additional dynamic object attributes in the database system by means of the archive system if the database system does not automatically create them when the value is first assigned,
querying all the objects in the database system for which the value/values of the one or more additional dynamic object attributes is/are empty or do not correspond to the value that is the result of a hash function relating to the respective object attribute or attributes in the database system,
searching and finding the queried objects in the archive system,
copying the object attributes from the database system to the archive system, and
marking the processed query result in the database system by writing the value that is the result of a hash function relating to the respective object attribute or attributes in the database in the form in which it was returned by the query to the respectively corresponding additional dynamic object attribute of the database system.

2. The method defined in claim 1, wherein only one additional dynamic object attribute is generated in the database system, to which, as a value, the archive system assigns the result of a hash function relating to the attributes to be synchronized, and the query accordingly compares the additional dynamic object attribute with the result of the hash function relating to the attributes to be synchronized.

3. The method defined in claim 1, further comprising the step of, instead of the value of the corresponding attribute in the archive system, the result of a hash function relating thereto is assigned as a value to the additional dynamic attributes created per attribute to be synchronized, and the query accordingly compares the additional dynamic object attribute with the result of the hash function relating to the respective attributes to be synchronized.

4. The method defined in claim 1, wherein the hash function used contains additional information.

5. The method defined in claim 1, further comprising the step of extending the hash function used by a salt in order to initiate a resynchronization of the database system.

6. The method defined in claim 1, further comprising the step of the archive system dividing the query of all the objects located in the database system into data blocks with a variable size.

7. The method defined in claim 1, further comprising the step of writing the objects of the database system found by the query, including their attributes, to the archive system if they are not already contained therein.

8. The method defined in claim 1, further comprising the step, on entry, of the archive system protecting all received objects against change by providing them with a signature or having them signed by a time stamp service while excepting the synchronized dynamic attributes from signing.

9. The method defined in claim 1, further comprising the step, when two or more archive systems access the same database system, of providing each of the respective additional dynamic object attributes with an identifier that contains specific identification characteristics of the respective archive systems.

10. The method defined in claim 1, further comprising the step of providing the database system with one separately accessible access-protected user account per user.

11. The method defined in claim 1, further comprising the step of providing the archive system with an access-protected administration account or a special trust setting that has or grants access to all user accounts of the database system.

12. The method defined in claim 10, further comprising the step of the archive system using a directory service for selecting certain accounts.

13. The method defined in claim 1, wherein the dynamic object attribute to be synchronized is a folder name or complete folder path.

14. The method defined in claim 13, wherein the objects are processed folder-by-folder in that the archive system
first requests a list of folders from the database system,
then calculates the hash value from the complete folder path of each folder,
for synchronization, then queries all objects of the folders of the database system for which the additional dynamic object attribute is empty or does not correspond to the hash value calculated for this folder,
after the object attribute has been synchronized, marks the processed query results by writing the calculated hash value to the additional dynamic object attribute.

15. The method defined in claim 1, wherein the archive system carries out further actions on the archive system and/or the database system based on a defined set of rules depending on the value of the synchronized object attributes.

16. The method defined claim 1, wherein the objects are emails.

17. A computer program for carrying out the method defined in claim 1 having program code stored on a machine-readable medium when the program is executed in a computer.

18. Use of the method defined in claim 1 for synchronizing a mail archive.

19. The method defined in claim 1, wherein the hash function used contains the serial number of the archive system, a secret key comprised of any value held in the archive system, and/or a token.
